(19) United States
(12) Patent Application Publication
(10) Pub. No.: US 2007/0141536 A1
(43) Pub. Date: Jun. 21, 2007

(54) Method and apparatus for designing a three dimensional model of a dental prosthesis

(76) Inventors: Robin Provost, Quebec (CA); Jean-Marc Perot, Quebec (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/534,001

(22) PCT Filed: Nov. 5, 2002
(86) PCT No.: PCT/CA02/01677

§ 371 Date: Apr. 4, 2006

(51) Int. Cl. A61C 5/10

(52) U.S. Cl. 433/223

(57) ABSTRACT

A method and system is provided for designing a three dimensional model of a dental prosthesis. Separate components having distinct functions are identified in the prosthesis and designed separately. The components are then juxtaposed spatially to form the dental prosthesis model. Different designing tools are used to design each component separately such that each shape is matched with an editing and designing tool that best suits its particularities.

### FIELD OF THE INVENTION

The invention relates to designing a three dimensional model of a dental prosthesis. More specifically, it relates to designing a three dimensional model when the prosthesis comprises discontinuities and multiple important surface variations.

### BACKGROUND OF THE INVENTION

Computer assisted design systems that mathematically model a dental prosthesis surface are quickly confronted to difficulties. The surface of a tooth is very complex and presents multiple discontinuities and significant surface variations.

Furthermore, when a frame is constructed for a prosthesis while taking into account the extrados, the intrados, and conceptual parameters such as minimum thickness of the ceramic, contact points, and occlusion. and then mechanical elements are added to ensure a protective function, linking function, or other, it becomes almost impossible to unite all of these elements into one surface model. The user of such a computer assisted design system is restrained by this fundamental limitation of the technology.

The dental computer assisted design systems currently in the state of the art can only produce simple frame shapes, such as dilatation of preparation for a simple coping, multiple simple copings linked by cylinders to form a bridge frame, etc. Patent application number PCT/FR96/02055 describes how to design a prosthesis by calculating only one surface that respects different constraints related to the extrados, intrados, and minimum ceramic thickness.

Moreover, since the lifetime of a dental prosthesis and the comfort of the wearer depend on the quality of the design, there is a need to improve the tools used for such designs and overcome the drawbacks of the present state of the art.

### SUMMARY OF THE INVENTION

Accordingly, an object of the present invention is to overcome the drawbacks of the present state of the art.

Another object of the present invention is to facilitate the designing process of a prosthesis.

Yet another object of the present invention is to provide designing tools capable of designing shapes of high complexity.

According to a first broad aspect of the present invention, there is provided a method for designing a dental prosthesis, the method comprising: identifying a plurality of components of the dental prosthesis to be designed, each one of the plurality of components having a distinct function; designing each of the plurality of components separately using virtual tools to produce virtual designs and generating separate data sets, while maintaining a relative reference among the components in a common reference frame; and producing a dental prosthesis model data set representing the dental prosthesis using all of the separate data sets.

Preferably, different designing tools are used for each separate component such that particularities of each component to be designed are matched with a designing tool that is best suited for the particular component.

According to a second broad aspect of the present invention, there is provided a method for producing a dental prosthesis, the method comprising: acquiring three dimensional digital data relating to a patient's dentition; identifying each separate component of the dental prosthesis to be designed having a distinct function; designing each of the components separately using the three dimensional data and using virtual toots to produce virtual designs of each of the components and generating separate data sets, while maintaining a relative reference among the components in a common reference frame; producing a dental prosthesis model data set representing the dental prosthesis using all of the separate data sets; and producing the dental prosthesis using the dental prosthesis model data set.

According to a third broad aspect of the present invention, there is provided a computer data signal embodied in a carrier wave comprising data resulting from a method for designing a dental prosthesis, the method comprising: identifying each separate component of the dental prosthesis to be designed having a distinct function; designing each of the components separately using virtual tools to produce virtual designs of each of the components and generating separate data sets, while maintaining a relative reference among the components in a common reference frame; and producing a dental prosthesis model data set representing the dental prosthesis using all of the separate data sets.

According to a fourth broad aspect of the present invention, there is provided a system for producing a dental prosthesis model, the system comprising: a data store module for storing separately a plurality of components of the dental prosthesis to be designed, wherein a relative reference is maintained among the plurality of components in a common reference frame; a designing module for designing each of the plurality of components separately using virtual tools to produce virtual designs of the plurality of components and generating separate data sets; and an output module for associating each of the separate data sets together and outputting the separate data sets together to a manufacturing device.

Preferably, the designing module also comprises a plurality of designing tools such that at least one of the plurality of components is modeled with a different designing tool than a remainder of the plurality of components.

### BRIEF DESCRIPTION OF THE DRAWINGS

These and other features, aspects and advantages of the present invention will become better understood with regard to the following description and accompanying drawings wherein:

FIG. 1 is an example of a prosthesis to be designed separated into its various components;

FIG. 2 is another example of a prosthesis to be designed separated into its various components;

FIG. 3 is a schematic of a model of two components for a prosthesis to be designed;

FIG. 4 is a schematic of all components of a prosthesis model combined together;

FIG. 5 is a schematic of a prosthesis model with an editing tool for one component;

FIG. 6 is a flow chart of a method for designing a prosthesis according to the present invention;

FIG. 7 is a flow chart of a method producing a prosthesis according to the present invention; and

FIG. 8 is a block diagram of a system according to the present invention.

### DETAILED DESCRIPTION OF THE PREFERRED EMBODIMENT

Throughout the description, the term designing is to be understood as meaning creating the initial three dimensional shape representing a component or element to be modeled, and editing the model to obtain a desired shape. Modeling and designing are used interchangeably throughout the text. Modeling can be done using various modeling tools, such as cloud of points, triangulation, Bezier, or any other modeling tool known to a person skilled in the art. Editing tools generally correspond to the modeling tool used and can comprises functions such as scaling, rotating, adjusting length/width/height/depth parameters, selecting from a predefined set of elements having different parameters, and surface adjustment.

The present invention is based on the principle of separating the type of modeling done as a function of the distinct function of each element or component to model, and to maintain this information separate until the fabrication process, which is to be considered as the final combination. By spatially juxtaposing all of the different elements into a common reference frame taken from the clinical frame of reference, an extremely complex surface can be reconstructed from a plurality of simple elements. The clinical frame of reference is to be understood as the patient's dentition as each element is referenced together in the mouth. The clinical reference frame can be obtained by scanning the dentition directly and obtaining three dimensional digital data representing the patient's dentition. A model can also be made of the dentition by using plaster and creating a negative cast of the dentition, which then becomes a three dimensional model. This model is then scanned to obtain the three dimensional digital data representing the patient's dentition.

The approach of separating a prosthesis to be modeled into separate components allows the designer to maintain a very good local coherence between the surface of each separate element. The interactive component of designing is optimized as a function of the specific editing parameters of each element. Also, the designer can locally adjust one element without affecting any of the other elements.

The intrados of a prosthesis must follow random and complex shapes. It can be modeled using a cloud of points or a simple surface modeling method such as triangulation. Specific parameters are typically dilatation for the sealing cement and the adjusting zone along the finishing line.

The extrados of the prosthesis must respond to high level editing functions in order to facilitate the designing of the tooth and control its interaction with the clinical model (adapting to the adjacent arch and occlusion). Its modeling could, for example, be based on more complex surface models such as Bezier curves, b-spline curves, Non-Uniform Rational B-spline (NURBs) curves, or other types of curves. It can be appreciated that for the extrados, the concept can be extended by dividing the tooth surface into unitary elements such as cuspid blocks, marginal ridges blocks, sulci blocks, etc. Spatially juxtaposing these unitary blocks allows the reconstruction of a complete crown. This concept can also be extended to any component having a distinct function, wherein modeling and editing is facilitated by breaking the component down into a plurality of elements. The elements can be modeled using the same or different modeling tools. The elements can be edited separately and combined together in the same fashion as the components of the prosthesis are combined together. The component can be edited once the individual elements are integrated into one.

A simple or anatomical coping, due to Its various constraints such as minimum thickness and reduction value to manage ceramic thickness, can be modeled using a modeling tool of medium complexity such as triangulation.

Additional elements such as the palatal band and the occlusal contact, which use partial information from the extrados (complex modeling level), the coping (medium modeling level), and a linking surface of simple modeling level can be modeled using a mixture of techniques or a triangulation technique. It can be appreciated that any individual component can be modeled using a plurality of different modeling techniques.

An attachment (a mechanical link temporarily or permanently solidifying two separate elements such as crosshead guides, retention spheres, etc) can be modeled by using industrial standards such as a DXF file or solidworks. The computer-assisted design tools will be capable of managing and manipulating these shapes in the common reference frame of the clinical model. An attachment is a typical type of component with very specific shapes, i.e. a sphere, rectangles, etc. These elements can be chosen from a set of predefined elements having different dimensions. Alternatively, the entire attachment can be selected from a set of attachments corresponding to commercially available attachments with fixed dimensions.

A telescopic crown comprising complex geometrical zones (such as in its extrados) and simple zones (planar surfaces guiding the mounting and dismounting of the prosthesis) can combine two types of modeling. The inlay/onlay is a combination of the extrados and intrados. A standard dental implant could be based on a mechanical description in a DXF format.

Combining all of the separate components into one surface can be done once each separate component has been designed. The choice of final modeling tool is directly linked to the manufacturing process allowing the realization of the virtual design. For example, a manufacturing process using rapid prototyping will preferably use a format of type STL. A software used to calculate tool paths for a digital machining tool will preferably use a format of type IGES or Cathia.

The final combination can also be done lower in the fabrication chain. For example, the machining tool can receive the G code allowing the production of each part of the prosthesis that can be produced by the machining tool. The production of these different pieces is done in the common reference frame of the machining tool and will produce the prosthesis in one piece. This approach allows the exterior shape of the prosthesis to be respected, while optimizing the results. Furthermore, the machining strategy can be optimized as a function of the part to be machined. For example, a simple geometrical surface with a good finishing but constraining axes of production would necessitate a particular approach compared to an extrados or intrados.

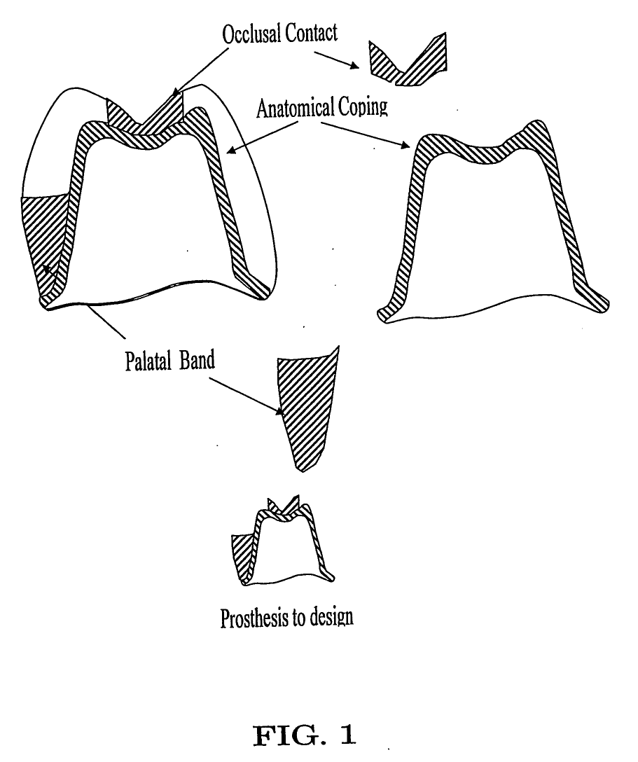

FIG. 1 is a first example of a prosthesis to be designed and fabricated using the present invention. The prosthesis in the figure is separated into 3 components: the occlusal contact, the anatomical coping, and the palatal band. Each component is designed separately using a designing tool that is ideal for the particularities of each component. The components are chosen as a function of the distinct function they have within the prosthesis. From the figure, it can be appreciated that designing a single three dimensional model representing the entire prosthesis is of higher complexity than having each component designed separately. There are angles that need to be taken into account that are not evident to design with a simple designing tool. Therefore, separating the model into components of lower complexity levels allows a simpler design of each component. Once the components are designed separately, they are juxtaposed into a common reference frame that corresponds to a reference frame of the clinical model.

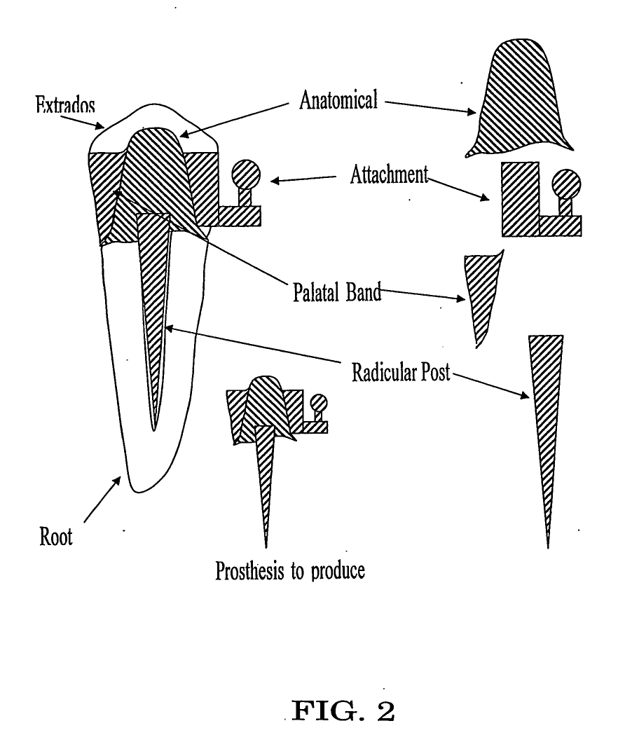

FIG. 2 is yet another example of a prosthesis to be designed and fabricated using the present invention. In this case we have an anatomical coping, a radicular post, a palatal band, and an attachment. The attachment corresponds to a standard design already available commercially. For this reason, it is ideal to use a vectorial editing tool to make such a design since the shape is very linear. The same could be said about the radicular post, which also has a linear shape. Such operations as scaling, rotating, etc, can be performed on these types of shapes. However, the other components of the prosthesis, such as the palatal band and the anatomical coping, would not benefit from using a vectorial editing tool since the surfaces are substantially non-linear in nature. In this case, modeling tools of higher complexity would better suit these shapes.

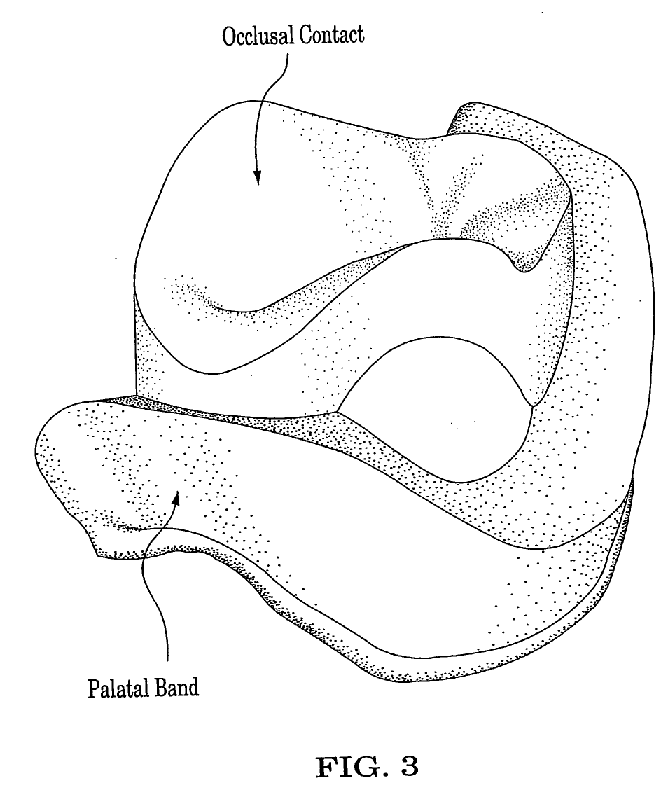

Additionally, when designing a separate component, information from another component may be used to help in the design. For example, the occlusal contact and palatal band may intersect at a common surface. In this case, the information identifying the boundaries of the palatal band are necessary for the design of the occlusal contact. This can be seen from FIG. 3, which shows a palatal band and an occlusal contact. It can be seen from the figure that several of the surfaces forming the two components interact. For this reason, information from one may be used in the design process of the other.

Alternatively, certain components may be designed without regards to another component, wherein the two components have at least a portion of a surface in common. In this case, a component is designed to overlap the other component along the common surface. An example can be seen in FIG. 2, where the radicular post and the anatomical coping intersect along a surface. The shape of the intersecting surface is irrelevant for both components and therefore disregarded during the design process. When the two components are combined, the radicular post. is simply overlapped onto the anatomical coping.

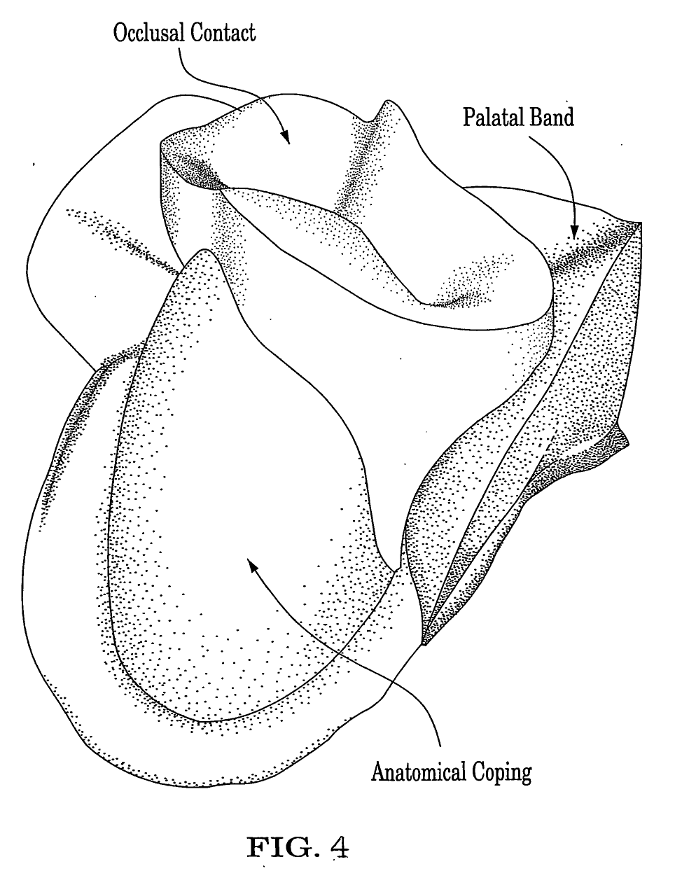

FIG. 4 is an example of a dental prosthesis model once all of the components have been designed separately and combined. Each component is integrated to form a single three dimensional model. Smoothing is done at the interfaces of each component to mesh each component together and provide a smooth three dimensional surface.

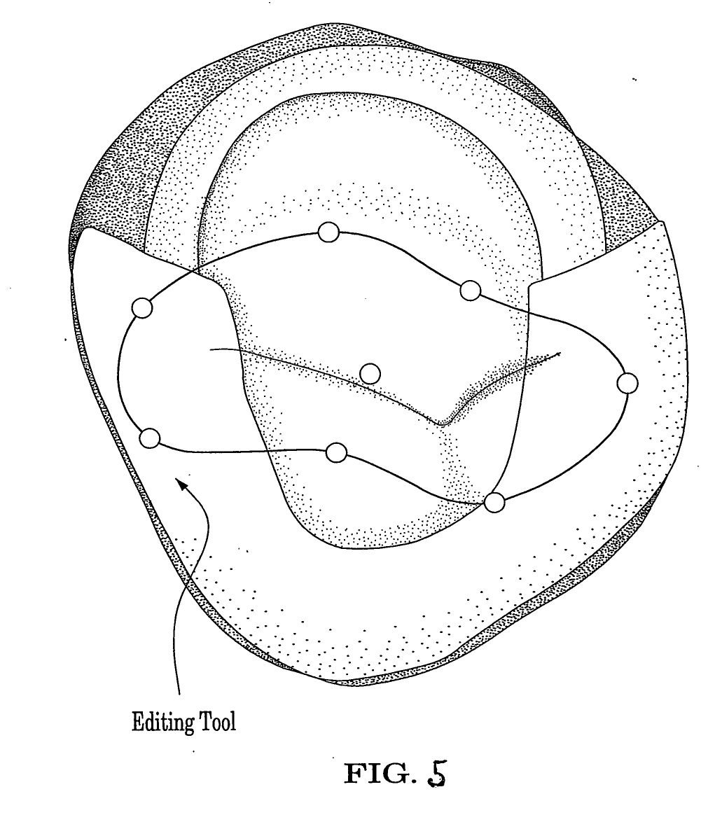

FIG. 5 is a dental prosthesis model having all of the components combined together and wherein editing of the separate components is still possible. The editing tool seen on the figure is a series of markers connected together by a flexible link. The markers are placed at specific locations by the user and fixed in place. When an individual marker is moved, the surface surrounding that marker all the way to the next marker moves according to the position to which the marker is moved to, the further away the surface is from the marker, the less it will move. Although the markers in the figure appear to cover a plurality of components, they all belong to one component and do not impact the other components. However, if one of the other components was designed using information from the component currently being edited, then this other component would have to be readjusted such that it corresponds to the new data set generated by the edited component.

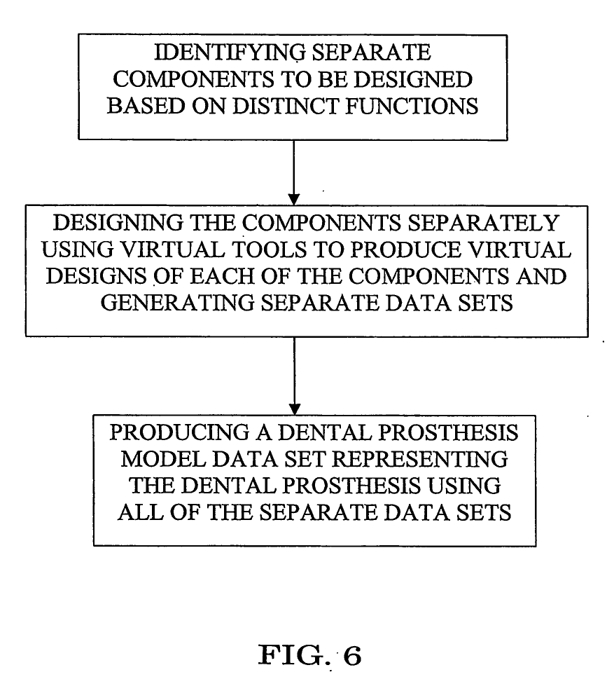

FIG. 6 is a flowchart of a method for designing a dental prosthesis model according to the invention. The first step of the method is to identify a plurality of components of the prosthesis to be designed, the distinction being based on the function provided by the component in the prosthesis. Therefore, for each role played in the prosthesis, such as the extrados, the intrados, the palatal band, etc, a component is identified as being distinct. The next step is to design the components using virtual tools and generate separate data sets for each component. During this step, a relative positioning is maintained between the components such that they correspond to a common reference frame. The last step is to produce a dental prosthesis model data set using all of the separate data sets. This can be done in several ways. A mathematical model can be built from the different data sets such that one three dimensional model is formed by adding all of the different components. Alternatively, the separate data sets may be juxtaposed spatially in a system that places them in a common reference frame, such as a machining tool.

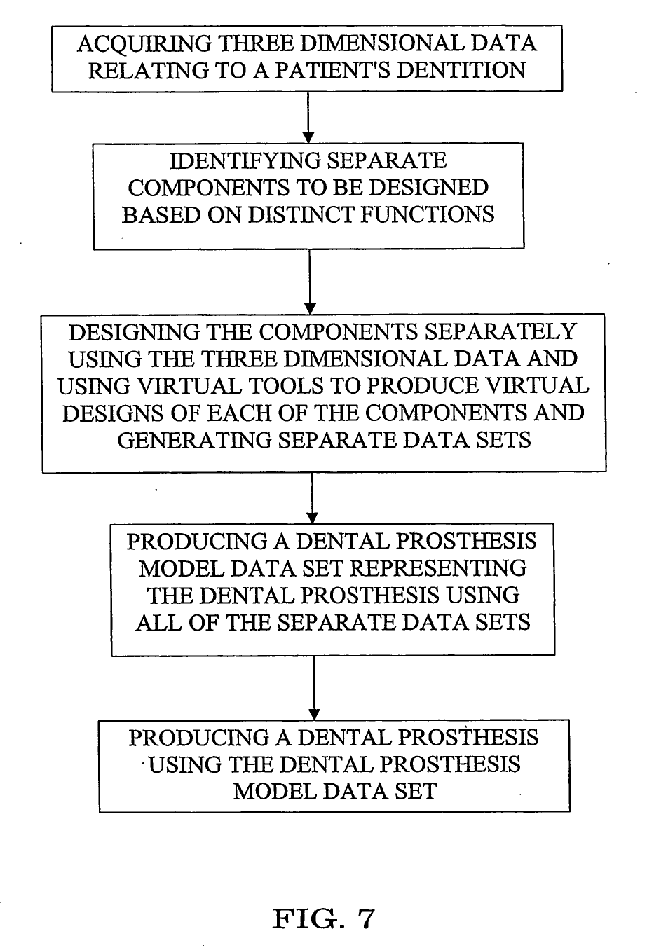

FIG. 7 is a flowchart for the method of producing a dental prosthesis according to the present invention. The first step is to acquire digital data corresponding to a patient's dentition. This can be done by either scanning directly the mouth of a patient or scanning a dental model made from a casting mold of a patient's dentition. Once the data is acquired, the different components of the prosthesis are identified. The components are then designed separately using virtual design tools and separate data sets are generated for each component. A dental prosthesis model data set is produced using the separate data sets. A dental prosthesis is then produced using the dental prosthesis model data set. The dental prosthesis can be produced using rapid prototyping, machining, a lost wax method, or any other type of manufacturing process known to a person skilled in the art.

The methods described by the flowcharts in FIGS. 6 and 7 can comprise the additional feature of using different designing tools with each component. The particular characteristics of each component to be designed are matched with a designing tool that will best suit the purpose of designing and editing the component.

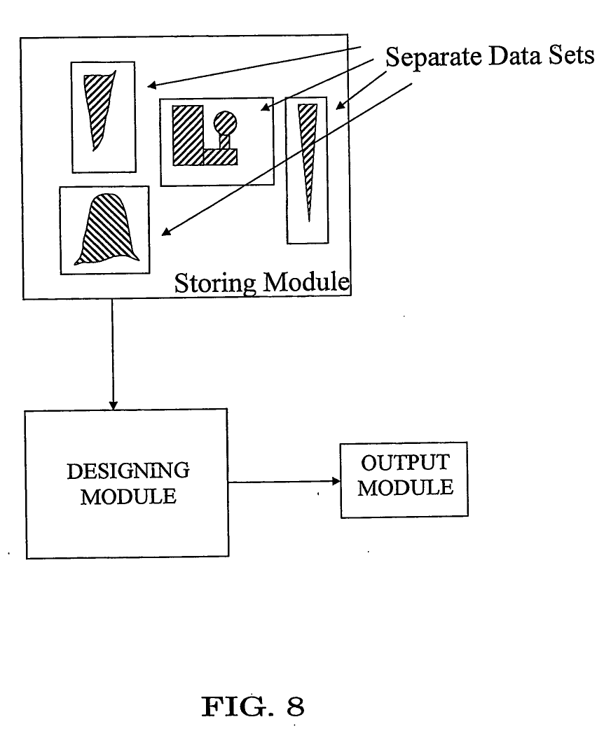

FIG. 8 shows a system for designing a prosthesis according to the present invention. A data store module is used for storing separately a plurality of components of the dental prosthesis to be designed. The components have been identified from a prosthesis based on the function of each component within the prosthesis. Although the components are stored separately, a relative reference is maintained amongst them in a common reference frame. A designing module is used to design each component separately. The components may simply be designed separately in order to facilitate the designing process. Additionally, the designing module may comprise multiple designing tools, wherein each designing tool has different editing functions that are better suited for a specific type of component. For example, an AutoCAD type of designing tool is best suited for a component have linear angles and surfaces, such as an attachment. Alternatively, a designing tool that works with triangulation would be better suited for a component needing special editing at a plurality of points on its surface, such as a palatal band. The designing Mrodule produces separate data sets for each component designed virtually The components are designed within a common reference frame and their relative positions are maintained. Separate data sets are generated for each of the separate components. The separate data sets are then sent to an output module, wherein the separate data sets are associated together and output together to a manufacturing device.

There are various embodiments for the output module. A first would be a module wherein associating the separate data sets comprises a mathematical juxtaposition that is done in space such that a single three dimensional model is formed. A mesh is placed on top of the juxtaposed components to smooth the intersections between the surfaces and produce a complete prosthesis model. This model can then be sent to a rapid prototyping machine in order to produce the prosthesis in one piece.

Alternatively, the separate data sets are simply concatenated or collected together and sent to a machining tool and the tool juxtaposes the components in space. A machining tool then machines the prosthesis by following an outer perimeter of the prosthesis formed by the addition of the separate components. To ensure that the machining tool does not machine each component separately, the dimensions of the components are adjusted such that they overlap with each other and do not provide any space in between. The machining tool is then forced to remain on the outer perimeter of the model and the prosthesis is produced in one piece.

The designing module may comprise a plurality of designing tools such that at least one of the components is modeled with a different designing tool than the remained of the components. One of the designing tools can comprises a selector for selecting an element from a predefined set of elements. Another designing tool may comprises a cursor to adjust width/heighttlength/depth of a component. Yet another designing tool may comprise a scaling tool for scaling the components, or a surface adjustment marker for displacing or deforming a portion of the surface on which the surface adjustment marker is placed.

Additionally, multiple tools can be used to design one component. The formats used to save the data sets can be Drawing Exchange Format (DXF, AutoCAD), Inset Graphics Format (IGF), or others. The format used generally depends on the modeling tool used. For example, in order to save a shape that was modeled using Bezier curves in an STL format (which is often used for rapid prototyping), an applied filter performs a triangulation and the editing functions that were originally available are lost. This is usually done towards the end of the design process once the model is set to its final shape. An alternative format to save a shape modeled using Bezier curves is IGS.

While illustrated in the block diagrams as ensembles of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted-that the present invention can be carried out as a method, can be embodied in a system, a computer readable medium or an electrical or electro-magnetical signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A method for designing a dental prosthesis, the method comprising:
identifying a plurality of components of said dental prosthesis to be designed, each one of said plurality of components having a distinct function;
designing each of said plurality of components separately using virtual tools to produce virtual designs and generating separate data sets, while maintaining a relative reference among said components in a common reference frame; and
producing a dental prosthesis model data set representing said dental prosthesis using all of said separate data sets.

2. A method as claimed in claim 1, wherein said designing each of said plurality of components separately comprises selecting and using a different designing tool for each one of said plurality of components such that different editing functions in each of said different designing tools are used when designing said components.

3. A method as claimed in claim 1, wherein said producing a dental prosthesis model data set comprises integrating said separate data sets into a single three dimensional virtual model.

4. A method as claimed in claim 3, wherein said producing a dental prosthesis model data set comprises editing said single three dimensional virtual model once all of said components have been integrated together.

5. A method as claimed in claim 4, wherein said editing said single three dimensional model data set comprises editing one of said plurality of components without affecting a remainder of said plurality of components.

6. A method as claimed in claim 1, wherein said producing a dental prosthesis model data set comprises collecting together each of said separate data sets for transmission to a manufacturing tool.

7. A method as claimed in claim 2, wherein said editing functions of one of said different designing tools is a selection of an element from a predefined set of elements.

8. A method as claimed in claim 2, wherein said editing functions of one of said different designing tools is an adjustment of width, length, and height parameters.

9. A method as claimed in claim 2, wherein said editing functions of one of said different designing tools is scaling.

10. A method as claimed in claim 2, wherein said editing functions of one of said different designing tools is a surface adjustment.

11. A method as claimed in claim 10, wherein said surface adjustment comprises using virtual handles placed on a surface at specific locations and used to deform said surface at said specific locations.

12. A method as claimed in claim 1, wherein said designing at least one of said plurality of components comprises using information from a data set generated by at least another one of said plurality of components.

13. A method as claimed in claim 1, wherein said designing comprises designing at least one of said plurality of components without regards to another one of said plurality of components having at least a portion of a common surface with said one of said plurality of components, and wherein said one of said plurality of components is designed to overlap said another one-of said plurality of components along said at least a portion of a common surface.

14. A method as claimed in claim 1, wherein said designing comprises breaking down at least one of said plurality of components into multiple elements.

15. A method as claimed in claim 14, wherein said designing comprises using multiple designing tools for a single one of said plurality of components.

16. A method for producing a dental prosthesis, the method comprising:
acquiring three dimensional digital data relating to a patient's dentition;
identifying each separate component of said dental prosthesis to be designed having a distinct function;
designing each of said components separately using said three dimensional data and using virtual tools to produce virtual designs of each of said components and generating separate data sets, while maintaining a relative reference among said components in a common reference frame;
producing a dental prosthesis model data set representing said dental prosthesis using all of said separate data sets; and
producing said dental prosthesis using said dental prosthesis model data set.

17. A method as claimed in claim 16, wherein said designing each of said components separately comprises selecting and using a different designing tool for each of said separate component such that different editing functions in each of said different designing tools are used when designing said components.

18. A method as claimed in claim 16, wherein said producing a dental prosthesis model data set further comprises integrating said separate data sets into a single three dimensional virtual model.

19. A method as claimed in claim 18, wherein said producing a dental prosthesis model data set comprises editing said single three dimensional virtual model once all of said components have, been integrated together.

20. A method as claimed in claim 19, wherein said editing said single three dimensional model data set comprises editing one of said plurality of components without affecting a remainder of said plurality of components.

21. A method as claimed in claims 16, wherein said producing a dental prosthesis model data set comprises collecting together each of said separate data sets for transmission to a manufacturing tool.

22. A method as claimed in claims 16, wherein said producing a dental prosthesis further comprises producing said prosthesis in one piece.

23. A method as claimed in claim 22, wherein said producing a dental prosthesis model data set further comprises sending each of said separate data sets to a manufacturing tool.

24. A method as claimed in claim 16, wherein said editing functions of one of said different designing tools is a selection of an element from a predefined set of elements.

25. A method as claimed in claim 24, wherein said editing functions of one of said different designing tools is an adjustment of width, length, and height parameters.

26. A method as claimed in claim 25, wherein said editing functions of one of said different designing tools is scaling.

27. A method as claimed in claim 26, wherein said editing functions of one of said different designing tools is a surface adjustment.

28. A method as claimed in claim 27, wherein said surface adjustment comprises using virtual handles placed on a surface at specific locations and used to deform said surface at said specific locations.

29. A method as claimed in claim 16, wherein said designing at least one of said plurality of components comprises using information from a data set generated by at least another one of said plurality of components.

30. A method as claimed in claim 16, wherein said designing comprises designing at least one of said plurality of components without regards to another one of said plurality of components having at least a portion of a common surface with said one of said plurality of components, and wherein said one of said plurality of components is designed to overlap said another one of said plurality of components along said at least a portion of a common surface.

31. A method as claimed in claim 16, wherein said designing comprises breaking down at least one of said plurality of components into multiple elements.

32. A method as claimed in claim 31, wherein said designing comprises using multiple designing tools for a single one of said plurality of components.

33. A computer readable memory for storing programmable instructions for use in the execution in a computer of the method of claim 1.

34. A computer data signal embodied in a carrier wave comprising data resulting from a method for designing a dental prosthesis, the method comprising.
identifying a plurality of components of said dental prosthesis to be designed having a distinct function;
designing each of said plurality of components separately using virtual tools to produce virtual designs of each of said plurality of components and generating separate data sets, while maintaining a relative reference among said components in a common reference frame; and
producing a dental prosthesis model data set representing said dental prosthesis using all of said separate data sets.

35. A system for designing a dental prosthesis, the system comprising:
a data store module for storing separately a plurality of components of said dental prosthesis to be designed, wherein a relative reference is maintained among said plurality of components in a common reference frame;
a designing module for designing each of said plurality of components separately using virtual tools to produce virtual designs of said plurality of components and generating separate data sets; and
an output module for associating each of said separate data sets together and outputting said separate data sets together to a manufacturing device.

36. A system as claimed in claim 35, wherein said designing module comprises a plurality of designing tools such that at least one of said plurality of components is modeled with a different designing tool than a remainder of said plurality of components.

37. A system as claimed in claim 35, wherein said output module comprises a tool for combining said separate data sets mathematically and producing a single three-dimensional virtual prosthesis model.

38. A system as claimed in claim 35, wherein at least one of said different designing tools comprises a selector for selecting an element from a predefined set of elements.

39. A system as claimed in claim 36, wherein at least one of said different designing tools comprises a cursor to adjust width, length, and height parameters.

40. A system as claimed in claim 36, wherein at least one of said different designing tools comprises a scaling tool.

41. A system as claimed in claim 36, wherein at least one of said different designing tools comprises a surface adjustment marker, wherein said marker is placed on a surface at a specific location and used to deform said surface at said specific location.
